(19) United States
(12) Patent Application Publication
(10) Pub. No.: US 2026/0288280 A1
(43) Pub. Date: Sep. 24, 2026

(54) ELECTRONIC DEVICE

(71) Applicant: Samsung Display Co., Ltd., Yongin-si (KR)

(72) Inventors: Bogeun YUK, Yongin-si (KR); Min-Hong KIM, Yongin-si (KR); Woomi BAE, Yongin-si (KR)

(73) Assignee: Samsung Display Co., Ltd., Yongin-si (KR)

(21) Appl. No.: 19/438,930

(22) Filed: Jan. 2, 2026

(30) Foreign Application Priority Data
Mar. 19, 2025 (KR) 10-2025-0035199

(51) Int. Cl. G06F 3/041

(52) U.S. Cl. CPC G06F 3/0418; G06F 3/0412; G06F 2203/04107; G06F 2203/04111; G06F 2203/04112

(57) ABSTRACT

An electronic device may include: a display layer configured to display an image, the display layer including a plurality of data lines and pixels each connected to a corresponding data line among the plurality of data lines; a display driver configured to output data signals to the plurality of data lines; a sensor layer on the display layer, the sensor layer including a plurality of first electrodes and a plurality of second electrodes; and a sensor driver configured to drive the sensor layer, wherein the plurality of first electrodes includes electrodes of a first group and electrodes of a second group, and wherein the sensor driver is configured to: output transmission signals to the electrodes of the first group; output compensation signals to the electrodes of the second group; and receive detection signals from the plurality of second electrodes.

### CROSS-REFERENCE TO RELATED APPLICATION

This application claims priority under 35 U.S.C. § 119 to Korean Patent Application No. 10-2025-0035199, filed on Mar. 19, 2025, in the Korean Intellectual Property Office, the disclosure of which is incorporated by reference herein in its entirety.

### BACKGROUND

### 1. Field

Some embodiments of the present disclosure described herein relate to an electronic device having a noise compensation function.

### 2. Description of Related Art

Multimedia electronic devices such as a television, a mobile phone, a tablet computer, a navigation system, a game console, etc., may display an image, and may provide, in addition to a general input method such as a button, a keyboard, a mouse, etc., a touch-based input method that allows a user to enter information or commands easily and intuitively.

Information disclosed in this Background section has already been known to or derived by the inventors before or during the process of achieving the embodiments of the present application, or is technical information acquired in the process of achieving the embodiments. Therefore, it may contain information that does not form prior art that is already known to the public.

### SUMMARY

According to some embodiments of the present disclosure, an electronic device including a sensor layer having a noise compensation function may be provided.

According to some embodiments of the present disclosure, an electronic device may include: a display layer configured to display an image, the display layer including a plurality of data lines and pixels each connected to a corresponding data line among the plurality of data lines; a display driver configured to output data signals to the plurality of data lines; a sensor layer on the display layer, the sensor layer including a plurality of first electrodes and a plurality of second electrodes; and a sensor driver configured to drive the sensor layer, wherein the plurality of first electrodes includes electrodes of a first group and electrodes of a second group, and wherein the sensor driver is configured to: output transmission signals to the electrodes of the first group; output compensation signals to the electrodes of the second group; and receive detection signals from the plurality of second electrodes.

According to some embodiments of the present disclosure, an electronic device may include: a display layer configured to display an image, the display layer including a plurality of data lines and pixels each connected to a corresponding data line among the plurality of data lines; a display driver configured to output data signals to the plurality of data lines; a sensor layer on the display layer, the sensor layer including a plurality of first electrodes, a plurality of second electrodes, and a guard signal line; and a sensor driver configured to drive the sensor layer, wherein the plurality of first electrodes includes electrodes of a first group and electrodes of a second group, and wherein the sensor driver is configured to: output transmission signals to the electrodes of the first group; output at least one compensation signal to the electrodes of the second group or the guard signal line; and receive detection signals from the plurality of second electrodes.

According to some embodiments of the present disclosure, an electronic device may include: a display layer configured to display an image, the display layer including a plurality of data lines; and pixels each connected to a corresponding data line among the plurality of data lines; a display driver configured to output data signals to the plurality of data lines; a sensor layer on the display layer, the sensor layer including a plurality of first electrodes and a plurality of second electrodes; a sensor driver configured to drive the sensor layer; and a processor configured to control an operation of the display driver and the sensor driver, wherein the plurality of first electrodes includes electrodes of a first group and electrodes of a second group, and wherein the sensor driver is configured to: output transmission signals to the electrodes of the first group; output compensation signals to the electrodes of the second group based on control of the processor; and receive detection signals from the plurality of second electrodes.

### BRIEF DESCRIPTION OF DRAWINGS

The above and other aspects and features of embodiments of the present disclosure will become apparent by describing in detail non-limiting example embodiments thereof with reference to the accompanying drawings.

FIG. 1 is a block diagram of an electronic device, according to an embodiment.

FIG. 2 is a schematic diagram of electronic devices, according to various embodiments.

FIG. 3 is a perspective view of an electronic device, according to an embodiment of the present disclosure.

FIG. 4 is a diagram describing an operation of an electronic device according to an embodiment of the present disclosure.

FIG. 5 is a cross-sectional view of an electronic device according to an embodiment of the present disclosure.

FIG. 6 is a cross-sectional view of an electronic device, according to an embodiment of the present disclosure.

FIG. 7 is a block diagram of a display layer and a display driver, according to an embodiment of the present disclosure.

FIG. 8 is a block diagram of a sensor layer and a sensor driver, according to an embodiment of the present disclosure.

FIG. 9A is a cross-sectional view of a sensor layer taken along a line I-I’ illustrated in FIG. 8, according to an embodiment of the present disclosure.

FIG. 9B is a cross-sectional view of a sensor layer taken along the line I-I’ illustrated in FIG. 8, according to an embodiment of the present disclosure.

FIG. 10 is an enlarged plane view of an area XX’ illustrated in FIG. 8.

FIG. 11 is a plan view of a sensing unit, according to an embodiment of the present disclosure.

FIG. 12 is a plan view illustrating an enlarged intersection of a sensing unit, according to an embodiment of the present disclosure.

FIG. 13 is a diagram illustrating noise generated in a data signal and a sensor layer, according to an embodiment of the present disclosure.

FIG. 14 is a diagram of a data pattern illustrated in an active area of an electronic device, according to an embodiment of the present disclosure.

FIG. 15 is a diagram illustrating in detail noise generated in a sensor layer, according to an embodiment of the present disclosure.

FIG. 16 is a waveform diagram of transmission signals, according to an embodiment of the present disclosure.

FIG. 17 is a block diagram of a sensor layer and a sensor driver, according to an embodiment of the present disclosure.

FIG. 18 is a waveform diagram of a transmission signal, a compensation signal, and a data signal, according to an embodiment of the present disclosure.

FIG. 19 is a waveform diagram of noise generated in an electrode outputting a data signal, a compensation signal, and a detection signal, according to an embodiment of the present disclosure.

FIG. 20 is a block diagram of a sensor layer and a sensor driver, according to an embodiment of the present disclosure.

### DETAILED DESCRIPTION

Embodiments of the present disclosure may be variously modified and realized in many different forms, and thus non-limiting example embodiments will be described in detail below and shown in the drawings. However, embodiments of the present disclosure are not limited to the specific example embodiments. All modifications, equivalents, and/or replacements of embodiments of the present disclosure are included in the spirit and scope of the present disclosure.

In the specification, when one component (or area, layer, part, or the like) is referred to as being “on,” “connected to,” or “coupled to” another component, it should be understood that the former may be directly on, connected to, or coupled to the latter, and also may be on, connected to, or coupled to the latter via a third intervening component.

Like reference numerals refer to like components. Also, in drawings, the thickness, ratio, and dimension of components may be exaggerated for effectiveness of description of technical contents. The term “and/or” includes one or more combinations of the associated listed items.

The terms “first,” “second,” etc., are used to describe various components, but the components are not limited by the terms. The terms are used only to differentiate one component from another component. For example, a first component may be named as a second component, and vice versa, without departing from the spirit or scope of the present disclosure. A singular form, unless otherwise stated, includes a plural form.

Also, the terms “under,” “beneath,” “on,” “above” are used to describe a relationship between components illustrated in a drawing. The terms are relative and are described with reference to a direction indicated in the drawing.

It will be understood that the terms “include,” “comprise,” “have,” etc., specify the presence of features, numbers, steps, operations, elements, or components, described in the specification, or a combination thereof, not precluding the presence or additional possibility of one or more other features, numbers, steps, operations, elements, components, or a combination thereof.

Unless defined otherwise, all terms (including technical and scientific terms) used herein have the same meaning as commonly understood by one of ordinary skill in the art to which this disclosure belongs. In addition, terms such as terms defined in commonly used dictionaries should be interpreted as having a meaning consistent with the meaning in the context of the related technology, and should not be interpreted as an ideal or excessively formal meaning unless explicitly defined in the present disclosure.

Hereinafter, non-limiting example embodiments of the present disclosure will be described with reference to accompanying drawings.

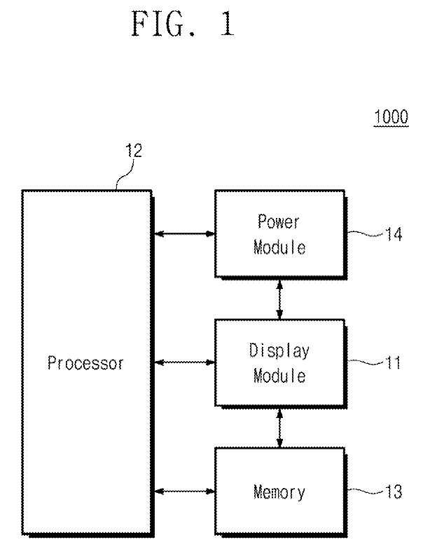

FIG. 1 is a block diagram of an electronic device 1000 according to an embodiment.

Referring to FIG. 1, the electronic device 1000 according to an embodiment may include a display module 11, a processor 12, a memory 13, and a power module 14.

The display module 11 may display an image. The image may include a still image as well as a dynamic image. The processor 12 may include at least one from among a central processing unit (CPU), an application processor (AP), a graphics processing unit (GPU), a communication processor (CP), an image signal processor (ISP), and a controller. The processor 12 may be configured to control operations of the display module 11.

The memory 13 may store data information for operations of the processor 12 or the display module 11. When the processor 12 executes an application stored in the memory 13, an image data signal and/or an input control signal may be transferred to the display module 11, and the display module 11 may process the received signal and may output image information through a display screen.

The power module 14 may include a power supply module, such as a power adapter or a battery device, and a power conversion module that converts power supplied by the power supply module to generate power for the operation of the electronic device 1000.

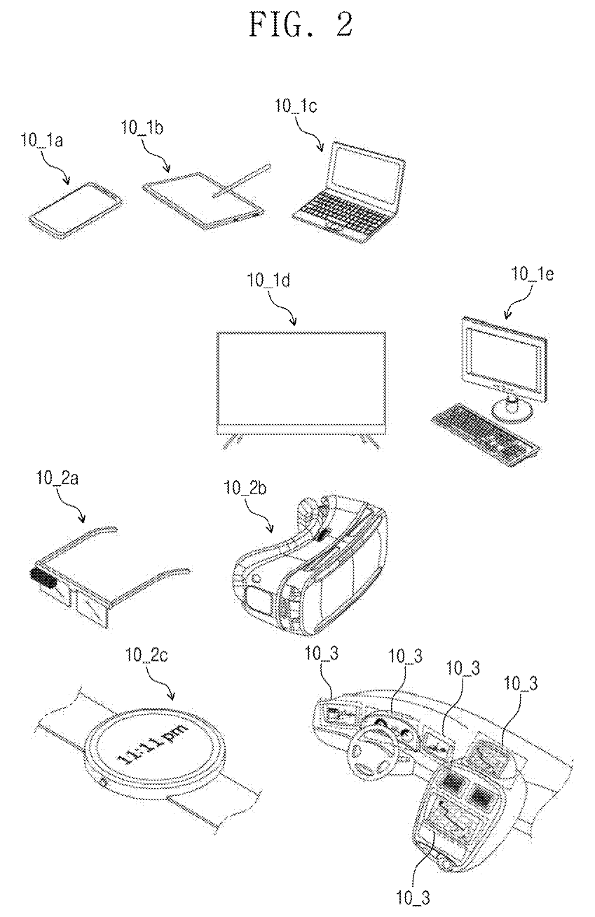

FIG. 2 is a schematic diagram of electronic devices, according to various embodiments.

Referring to FIG. 2, various electronic devices to which display devices according to the embodiments are applied may include not only image display electronic devices such as a smart phone 10_1a, a tablet PC 10_1b, a laptop computer 10_1c, a TV 10_1d, a desk monitor 10_1e, but also wearable electronic devices including display modules such as smart glasses 10_2a, a head-mounted display 10_2b, a smart watch 10_2c, etc., and vehicle electronic devices 10_3 including display modules such as a center information display (CID) placed on an instrument panel, a center fascia, or a dashboard of a vehicle, a room mirror display, etc.

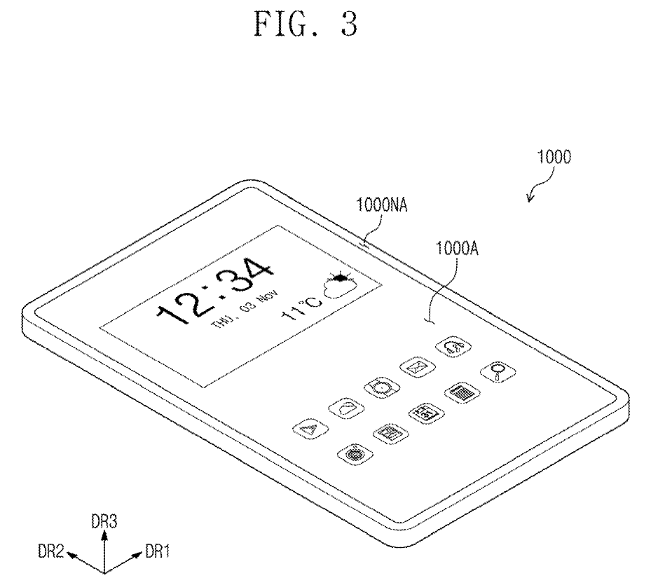

FIG. 3 is a perspective view of the electronic device 1000, according to an embodiment of the present disclosure.

Referring to FIG. 3, the electronic device 1000 may be activated, in response to an electrical signal. For example, the electronic device 1000 may be a mobile phone, a foldable mobile phone, a notebook computer, a television, a tablet computer, a car navigation system, a game console, or a wearable device, but is not limited thereto. FIG. 3 illustrates that the electronic device 1000 is a mobile phone.

An active area 1000A and a peripheral area 1000NA may be defined in the electronic device 1000. The electronic device 1000 may display an image through the active area 1000A. The active area 1000A may include a surface that extends in a first direction DR1 and a second direction DR2. The peripheral area 1000NA may surround the active area 1000A. In an embodiment of the present disclosure, the peripheral area 1000NA may be omitted.

The thickness direction of the electronic device 1000 may be parallel to a third direction DR3 crossing the first direction DR1 and the second direction DR2. Accordingly, front surfaces (or top surfaces) and rear surfaces (or bottom surfaces) of members constituting the electronic device 1000 may be defined based on the third direction DR3.

Although FIG. 3 illustrates the electronic device 1000 as a bar type electronic device, by way of example, embodiments of the present disclosure are not limited thereto.

For example, the descriptions provided below may be applied to various electronic devices such as a foldable electronic device, a rollable electronic device, or a slidable electronic device.

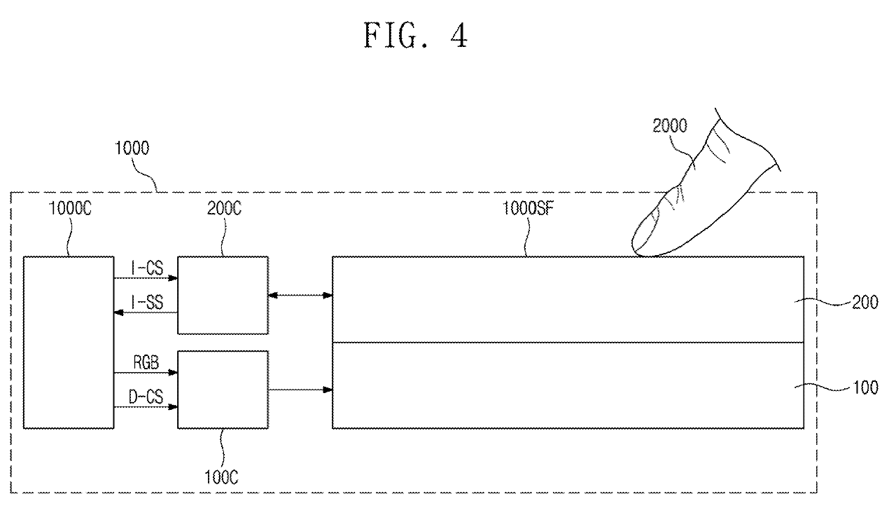

FIG. 4 is a diagram for describing an operation of the electronic device 1000, according to an embodiment of the present disclosure.

Referring to FIG. 4, the electronic device 1000 may include a display layer 100, a sensor layer 200, a display driver 100C, a sensor driver 200C, and a main driver 1000C.

The display layer 100 may be a component which actually generates an image. The display layer 100 may be a light emitting display layer. For example, the display layer 100 may include an organic light emitting display layer, an inorganic light emitting display layer, an organic-inorganic light emitting display layer, a quantum dot display layer, a micro light-emitting diode (LED) display layer, or a nano LED display layer.

The sensor layer 200 may be disposed on the display layer 100. The sensor layer 200 may sense an external input (e.g., an external input 2000) applied from the outside. The external input 2000 may include any input means capable of providing a change in capacitance. For example, the sensor layer 200 may sense not only a passive type input means such as a user’s body, but also an input by an active type input means providing a driving signal.

The main driver 1000C may control the overall operation of the electronic device 1000. For example, the main driver 1000C may control operations of the display driver 100C and the sensor driver 200C. The main driver 1000C may include at least one microprocessor, and may further include a graphics controller. The main driver 1000C may be referred to as an application processor, a central processing unit, or a main processor.

The display driver 100C may drive the display layer 100. The display driver 100C may receive image data RGB and a control signal D-CS from the main driver 1000C. The control signal D-CS may include various signals. For example, the control signal D-CS may include an input vertical synchronization signal, an input horizontal synchronization signal, a main clock, and a data enable signal. The display driver 100C may generate the vertical synchronization signal and the horizontal synchronization signal that control the timing of providing a signal to the display layer 100, based on the control signal D-CS.

The sensor driver 200C may drive the sensor layer 200. The sensor driver 200C may receive a control signal I-CS from the main driver 1000C. The control signal I-CS may include a mode determination signal that determines a driving mode of the sensor driver 200C, a signal that determines or controls at least one from among the magnitude and phase of transmission signals output (applied) to the electrodes of the sensor layer 200, and/or a clock signal.

The sensor driver 200C may calculate coordinate information of an input based on a signal received from the sensor layer 200 and may provide a coordinate signal I-SS including the coordinate information to the main driver 1000C. The main driver 1000C may allow an operation corresponding to a user input to be executed based on the coordinate signal I-SS. For example, the main driver 1000C may operate the display driver 100C such that a new application image is displayed on the display layer 100.

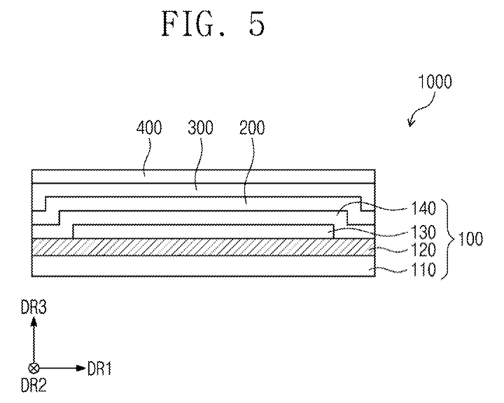

FIG. 5 is a cross-sectional view of the electronic device 1000, according to an embodiment of the present disclosure.

Referring to FIG. 5, the electronic device 1000 may include the display layer 100, the sensor layer 200, an anti-reflection layer 300, and a window 400.

The display layer 100 may include a base layer 110, a circuit layer 120, a light emitting element layer 130, and an encapsulation layer 140.

The base layer 110 may be a member that provides a base surface on which the circuit layer 120 is disposed. The base layer 110 may be a glass substrate, a metal substrate, a polymer substrate, or the like. However, embodiments of the present disclosure are not limited thereto. For example, the base layer 110 may be an inorganic layer, an organic layer, or a composite material layer.

The circuit layer 120 may be disposed on the base layer 110. The circuit layer 120 may include an insulating layer, a semiconductor pattern, a conductive pattern, and a signal line. An insulating layer, a semiconductor layer, and a conductive layer may be formed on the base layer 110 through a coating or deposition process, and the insulating layer, the semiconductor layer, and the conductive layer may then be selectively patterned through a plurality of photolithography processes. Thereafter, the semiconductor pattern, the conductive pattern, and the signal line included in the circuit layer 120 may be formed.

The light emitting element layer 130 may be disposed on the circuit layer 120. The light emitting element layer 130 may include a light emitting element. For example, the light emitting element layer 130 may include an organic light emitting material, an inorganic light emitting material, an organic-inorganic light emitting material, a quantum dot, a quantum rod, a micro-LED, or a nano-LED.

The encapsulation layer 140 may be disposed on the light emitting element layer 130. The encapsulation layer 140 may protect the light emitting element layer 130 from foreign substances such as moisture, oxygen, and dust particles.

The sensor layer 200 may be disposed on the display layer 100. The sensor layer 200 may be formed on the display layer 100 through a successive process. In this case, the sensor layer 200 may be expressed as being directly disposed on the display layer 100.

The phrase “being directly disposed” may indicate that a third component is not intervened between the sensor layer 200 and the display layer 100. In other words, an additionally adhesive member may not be interposed between the sensor layer 200 and the display layer 100. Alternatively, the sensor layer 200 may be bonded to the display layer 100 through an adhesive member. The adhesive member may include a typical adhesive or a sticking agent.

The anti-reflection layer 300 may be disposed on the sensor layer 200. The anti-reflection layer 300 may reduce reflectance of external light incident from the outside of the electronic device 1000. The anti-reflection layer 300 may be disposed directly on the sensor layer 200. However, embodiments of the present disclosure are not limited thereto, and an adhesive material may be placed between the anti-reflection layer 300 and the sensor layer 200.

The window 400 may be disposed above the anti-reflection layer 300. The window 400 may include an optically transparent insulating material. For example, the window 400 may include glass or plastic. The window 400 may have a multi-layer structure or a single-layer structure. For example, the window 400 may include a plurality of plastic films bonded to each other by an adhesive or may include a glass substrate and a plastic film bonded to each other by an adhesive.

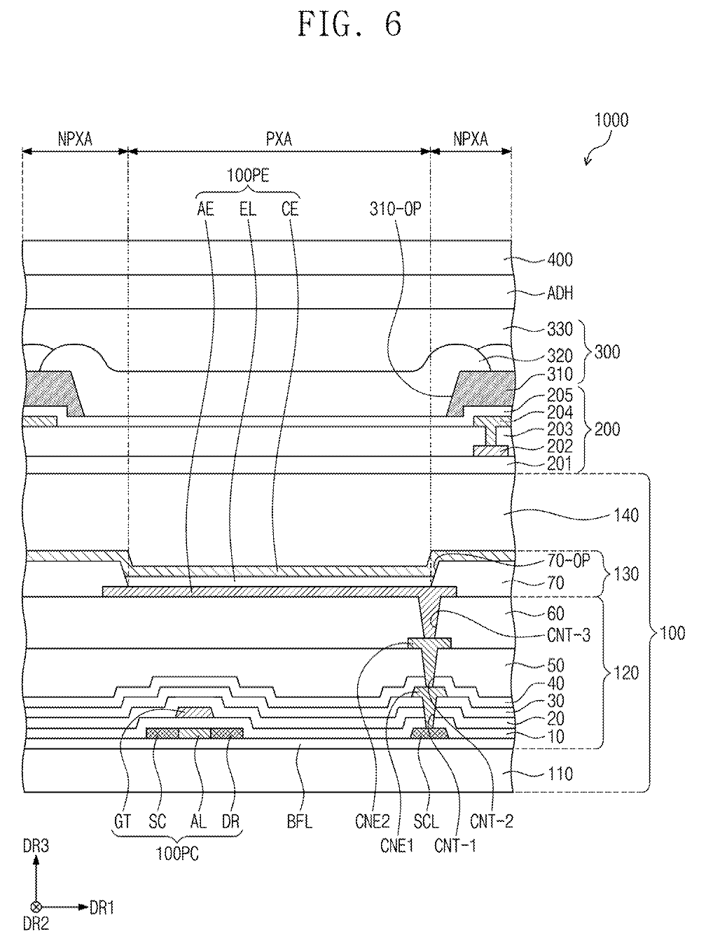

FIG. 6 is a cross-sectional view illustrating the electronic device 1000, according to an embodiment of the present disclosure.

Referring to FIG. 6, the electronic device 1000 may include the display layer 100, the sensor layer 200, the anti-reflection layer 300, an adhesive layer ADH, and the window 400. The adhesive layer ADH may be disposed between the anti-reflection layer 300 and the window 400. The adhesive layer ADH may include an adhesive with or without light transmission properties.

At least one inorganic layer may be formed on an upper surface of the base layer 110. The inorganic layer may include at least one from among aluminum oxide, titanium oxide, silicon oxide, silicon nitride, silicon oxynitride, zirconium oxide, and hafnium oxide. The inorganic layer may be formed of multiple layers. The multiple inorganic layers may constitute a barrier layer and/or a buffer layer. In an embodiment, the display layer 100 is illustrated as including a buffer layer BFL.

The buffer layer BFL may improve a bonding force between the base layer 110 and a semiconductor pattern. The buffer layer BFL may include at least one from among silicon oxide, silicon nitride, and silicon oxynitride. For example, the buffer layer BFL may include a structure in which at least one silicon oxide layer and at least one silicon nitride layer are alternately stacked.

The semiconductor pattern may be disposed on the buffer layer BFL. The semiconductor pattern may include polysilicon. However, embodiments of the present disclosure are not limited thereto, and the semiconductor pattern may include amorphous silicon, low-temperature polycrystalline silicon, or an oxide semiconductor.

FIG. 6 only illustrates a portion of the semiconductor pattern, and other portions of the semiconductor pattern may be further disposed in another area. Semiconductor patterns may be arranged across pixels based on a specific rule. The semiconductor pattern may have a different electrical property depending on whether the semiconductor pattern is doped or undoped. The semiconductor pattern may include a first area having higher conductivity and a second area having lower conductivity. The first area may be doped with an N-type dopant or a P-type dopant. A P-type transistor may be provided and include a doped area doped with a P-type dopant, and an N-type transistor may be provided and include a doped area doped with an N-type dopant. The second area may be a non-doped area or an area doped at a lower concentration than a concentration of the first area.

The conductivity of the first area may be greater than the conductivity of the second area, and the first area may actually serve as an electrode or a signal line. The second area may be an active area (or a channel) of a transistor. In other words, a portion of the semiconductor pattern may be an active area of a transistor, another portion thereof may be a source or a drain of the transistor, and another portion thereof may be a connection electrode or a connection signal line.

Each of the pixels may have an equivalent circuit including seven transistors, one capacitor, and a light emitting element, and the equivalent circuit diagram of the pixel may be modified in various forms. One transistor 100PC and one light emitting element 100PE included in the pixel are illustrated in FIG. 6 by way of example.

A source area SC, an active area AL, and a drain area DR of the transistor 100PC may be formed from the semiconductor pattern. In a cross-sectional view (e.g., FIG. 6), the source area SC and the drain area DR may extend in opposite directions from the active area AL. A portion of a connection signal line SCL formed from the semiconductor pattern is illustrated in FIG. 6. According to some embodiments, the connection signal line SCL may be connected to the drain area DR of the transistor 100PC in a plan view.

A first insulating layer 10 may be disposed on the buffer layer BFL. The first insulating layer 10 may overlap with a plurality of pixels in common and may cover the semiconductor pattern. The first insulating layer 10 may be an inorganic layer and/or an organic layer, and may have a single-layer structure or a multi-layer structure. The first insulating layer 10 may include at least one from among aluminum oxide, titanium oxide, silicon oxide, silicon nitride, silicon oxynitride, zirconium oxide, and hafnium oxide. In this embodiment, the first insulating layer 10 may be a single-layer silicon oxide layer. The insulating layer of the circuit layer 120 to be described later as well as the first insulating layer 10 may be an inorganic layer and/or an organic layer, and may have a single-layer structure or a multi-layer structure. The inorganic layer may include at least one of the above-described materials, but is not limited thereto.

A gate GT of the transistor 100PC may be disposed on the first insulating layer 10. The gate GT may be a part of a metal pattern. The gate GT may overlap with the active area AL. In the process of doping the semiconductor pattern, the gate GT may function as a mask.

A second insulating layer 20 may be disposed on the first insulating layer 10 and may cover the gate GT. The second insulating layer 20 may overlap with the pixels in common. The second insulating layer 20 may be an inorganic layer and/or an organic layer, and may have a single-layer structure or a multi-layer structure. The second insulating layer 20 may include at least one from among silicon oxide, silicon nitride, and silicon oxy nitride. In this embodiment, the second insulating layer 20 may have a multi-layer structure including a silicon oxide layer and a silicon nitride layer.

A third insulating layer 30 may be disposed on the second insulating layer 20. The third insulating layer 30 may have a single-layer structure or a multi-layer structure. For example, the third insulating layer 30 may have a multi-layer structure including a silicon oxide layer and a silicon nitride layer.

A first connection electrode CNE1 may be disposed on the third insulating layer 30. The first connection electrode CNE1 may be connected with the connection signal line SCL through a contact hole CNT-1 formed through the first insulating layer 10, the second insulating layer 20, and the third insulating layer 30.

A fourth insulating layer 40 may be disposed on the third insulating layer 30. The fourth insulating layer 40 may be a single silicon oxide layer. A fifth insulating layer 50 may be disposed on the fourth insulating layer 40. The fifth insulating layer 50 may be an organic layer.

A second connection electrode CNE2 may be disposed on the fifth insulating layer 50. The second connection electrode CNE2 may be connected to the first connection electrode CNE1 through a contact hole CNT-2 penetrating the fourth insulating layer 40 and the fifth insulating layer 50.

A sixth insulating layer 60 may be disposed on the fifth insulating layer 50 and may cover the second connection electrode CNE2. The sixth insulating layer 60 may be an organic layer.

The light emitting element layer 130 may be disposed on the circuit layer 120. The light emitting element layer 130 may include the light emitting element 100PE. For example, the light emitting element layer 130 may include an organic light emitting material, an inorganic light emitting material, an organic-inorganic light emitting material, a quantum dot, a quantum rod, a micro-LED, or a nano-LED. Hereinafter, the description will be given under the condition that the light emitting element 100PE is an organic light emitting element, but embodiments of the present disclosure are not particularly limited thereto.

The light emitting element 100PE may include a first electrode AE, a light emitting layer EL, and a second electrode CE.

The first electrode AE may be disposed on the sixth insulating layer 60. The first electrode AE may be connected to the second connection electrode CNE2 through a contact hole CNT-3 penetrating the sixth insulating layer 60.

A pixel defining film 70 may be disposed on the sixth insulating layer 60 and may cover a portion of the first electrode AE. An opening 70-OP may be defined in the pixel defining film 70. The opening 70-OP of the pixel defining film 70 may expose at least a portion of the first electrode AE.

The active area 1000A (refer to FIG. 1) may include an emission area PXA and a non-emission area NPXA adjacent to the emission area PXA. The non-emission area NPXA may surround the emission area PXA. In the present embodiment, the emission area PXA may be defined to correspond to the portion of the first electrode AE, which is exposed by the opening 70-OP.

The light emitting layer EL may be disposed on the first electrode AE. The light emitting layer EL may be disposed in an area corresponding to (e.g., overlapping with) the opening 70-OP. In other words, the light emitting layer EL may be independently formed for respective pixels. In the case where light emitting layers EL are separately formed for respective pixels, each of the light emitting layers EL may emit a light of at least one from among a blue color, a red color, and a green color. However, embodiments of the present disclosure are not limited thereto, and the light emitting layer EL may be connected with the pixels in common. In this case, the light emitting layer EL may provide blue light or white light.

The second electrode CE may be disposed on the light emitting layer EL. The second electrode CE may have an integral shape and may be commonly included in a plurality of pixels.

According to some embodiments, a hole control layer may be interposed between the first electrode AE and the light emitting layer EL. The hole control layer may be disposed in common in the emission area PXA and the non-emission area NPXA. The hole control layer may include a hole transport layer and may further include a hole injection layer. An electronic control layer may be disposed between the light emitting layer EL and the second electrode CE. The electron control layer may include an electron transport layer and may further include an electron injection layer. The hole control layer and the electron control layer may be formed, in common, in a plurality of pixels by using an open mask or an inkjet process.

The encapsulation layer 140 may be disposed on the light emitting element layer 130. The encapsulation layer 140 may include an inorganic layer, an organic layer, and an inorganic layer sequentially stacked, and layers constituting the encapsulation layer 140 are not limited thereto. The inorganic layers may protect the light emitting element layer 130 from moisture and oxygen, and the organic layer may protect the light emitting element layer 130 from a foreign material such as dust particles. The inorganic layers may include a silicon nitride layer, a silicon oxynitride layer, a silicon oxide layer, a titanium oxide layer, or an aluminum oxide layer. The organic layer may include, but is not limited to, an acrylic-based organic layer.

The sensor layer 200 may include a base layer 201, a first conductive layer 202, a sensing insulating layer 203, a second conductive layer 204, and a cover insulating layer 205.

The base layer 201 may be an inorganic layer including at least one from among silicon nitride, silicon oxy nitride, and silicon oxide. Alternatively, the base layer 201 may be an organic layer including an epoxy resin, an acrylate resin, or an imide-based resin. The base layer 201 may have a single-layer structure or may have a multi-layer structure stacked in the third direction DR3.

Each of the first conductive layer 202 and the second conductive layer 204 may have a single-layer structure or may have a multi-layer structure stacked in the third direction DR3.

A conductive layer of the single-layer structure may include a metal layer or a transparent conductive layer. The metal layer may include molybdenum, silver, titanium, copper, aluminum, or the alloy thereof. The transparent conductive layer may include a transparent conductive oxide, such as indium tin oxide (ITO), indium zinc oxide (IZO), zinc oxide (ZnO), or indium zinc tin oxide (IZTO), etc. In addition, the transparent conductive layer may include a conductive polymer such as poly(3,4-ethylenedioxythiophene) (PEDOT), metal nanowires, graphene, etc.

The conductive layer in the multi-layer structure may include metal layers. The metal layers may, for example, have a three-layer structure of titanium/aluminum/titanium. The multi-layered conductive layer may include at least one metal layer and at least one transparent conductive layer.

At least one of the sensing insulating layer 203 and the cover insulating layer 205 may include an inorganic film. The inorganic film may include at least one from among aluminum oxide, titanium oxide, silicon oxide, silicon nitride, silicon oxynitride, zirconium oxide, and hafnium oxide.

At least one from among the sensing insulating layer 203 and the cover insulating layer 205 may include an organic film. The organic film may include at least one from among acrylic resin, methacrylic resin, polyisoprene, vinyl-based resin, epoxy-based resin, urethane-based resin, cellulose-based resin, siloxane-based resin, polyimide-based resin, polyamide-based resin, and perylene-based resin.

The anti-reflection layer 300 may be disposed on the sensor layer 200. The anti-reflection layer 300 may include a split layer 310, a plurality of color filters 320, and a planarization layer 330.

The split layer 310 may be disposed to overlap with the conductive pattern of the second conductive layer 204. The cover insulating layer 205 may be disposed between the split layer 310 and the second conductive layer 204. In an embodiment of the present disclosure, the cover insulating layer 205 may be omitted.

The split layer 310 may prevent external light reflection by the second conductive layer 204. The material forming the split layer 310 is not particularly limited as long as it is a material that absorbs light. The split layer 310 may be a layer having a black color, and in an embodiment, the split layer 310 may include a black coloring agent. The black coloring agent may include a black dye or a black pigment. The black coloring agent may include carbon black, a metal such as chromium, or an oxide thereof.

A split opening 310-OP may be defined in the split layer 310. The split opening 310-OP may overlap with the light emitting layer EL. The color filter 320 may be disposed corresponding to (e.g., in) the split opening 310-OP. The color filter 320 may transmit light provided from the light emitting layer EL overlapping with the color filter 320.

The planarization layer 330 may cover the split layer 310 and the color filter 320. The planarization layer 330 may include an organic material, and the upper surface of the planarization layer 330 may include a flat surface. In an embodiment, the planarization layer 330 may be omitted.

In an embodiment of the present disclosure, the anti-reflection layer 300 may include a reflection adjustment layer instead of the color filters 320. For example, in the illustration of FIG. 6, the color filters 320 may be omitted, and the reflection adjustment layer may be added in the place where the color filters 320 are omitted. The reflection adjustment layer may selectively absorb some bands of light reflected from inside the display panel and/or the electronic device or light incident from outside the display panel and/or the electronic device.

For example, the reflection adjustment layer may absorb a first wavelength range of 490 nm to 505 nm and a second wavelength range of 585 nm to 600 nm, so that the light transmittance in the first wavelength range and the second wavelength range may be 40% or less. The reflection adjustment layer may absorb light of a wavelength outside the wavelength range of red, green, and blue light emitted from the light emitting layer EL. In this way, the reflection adjustment layer may prevent or minimize a decrease in the brightness of the display panel and/or the electronic device by absorbing light of a wavelength outside the wavelength range of red, green, or blue light emitted from the light emitting layer EL. In addition, at the same time, a decrease in the luminance efficiency of the display panel and/or the electronic device may be prevented or minimized, and visibility may be improved.

The reflection adjustment layer may be provided with an organic layer including a dye, a pigment, or a combination thereof. The reflection adjustment layer may include at least one from among a tetraazaporphyrin (TAP) compound, a porphyrin compound, a metal porphyrin compound, an oxazine compound, a squarylium compound, a triarylmethane compound, a polymethine compound, an anthraquinone compound, a phthalocyanine compound, an azo compound, a perylene compound, a xanthene compound, a diimmonium compound, a dipyrromethene compound, a cyanine compound, and a combination thereof.

In an embodiment, the reflection adjustment layer may have a transmittance of about 64% to 72%. The transmittance of the reflection adjustment layer may be adjusted depending on the content of pigments and/or dyes included in the reflection adjustment layer.

FIG. 7 is a block diagram of the display layer 100 and the display driver 100C, according to an embodiment of the present disclosure.

Referring to FIG. 7, the display layer 100 may include a plurality of scan lines SL1 to SLn, a plurality of data lines DL1 to DLm, and a plurality of pixels PX. Each of the plurality of pixels PX may be connected with a corresponding data line from among the plurality of data lines DL1 to DLm and may be connected with a corresponding scan line from among the plurality of scan lines SL1 to SLn. Here, “n” may be an integer greater than or equal to 2, and “m” may be an integer greater than or equal to 2. In an embodiment of the present disclosure, the display layer 100 may further include light emission control lines, and the display driver 100C may further include a light emission driving circuit that provides control signals to the light emission control lines. The configuration of the display layer 100 is not particularly limited.

Each of the scan lines SL1 to SLn may extend in the first direction DR1, and the scan lines SL1 to SLn may be arranged to be spaced apart from each other in the second direction DR2. Each of the data lines DL1 to DLm may extend in the second direction DR2, and the data lines DL1 to DLm may be arranged to be spaced apart from each other in the first direction DR1.

The display driver 100C may include a signal control circuit 100C1, a scan driving circuit 100C2, and a data driving circuit 100C3.

The signal control circuit 100C1 may receive the image data RGB and the control signal D-CS from the main driver 1000C (refer to FIG. 2). The control signal D-CS may include various signals. For example, the control signal D-CS may include an input vertical synchronization signal, an input horizontal synchronization signal, a main clock, and a data enable signal.

The signal control circuit 100C1 may generate a first control signal CONT1 and a vertical synchronization signal Vsync, based on the control signal D-CS, and may output the first control signal CONT1 and the vertical synchronization signal Vsync to the scan driving circuit 100C2.

The signal control circuit 100C1 may generate a second control signal CONT2 and a horizontal synchronization signal Hsync based on the control signal D-CS, and may output the second control signal CONT2 and the horizontal synchronization signal Hsync to the data driving circuit 100C3.

In addition, the signal control circuit 100C1 may output, to the data driving circuit 100C3, a driving signal DS obtained by processing the image data RGB to match to the operating condition of the display layer 100. The first control signal CONT1 and the second control signal CONT2 may be signals for the operation of the scan driving circuit 100C2 and the data driving circuit 100C3, and are not particularly limited thereto.

The scan driving circuit 100C2 may drive the plurality of scan lines SL1 to SLn in response to the first control signal CONT1 and the vertical synchronization signal Vsync. In an embodiment of the present disclosure, the scan driving circuit 100C2 may be formed in the same process as the circuit layer 120 (refer to FIG. 6) in the display layer 100, but is not limited thereto. For example, the scan driving circuit 100C2 may be implemented as an integrated circuit (IC) and may be directly mounted on a predetermined area of the display layer 100 or on a separate printed circuit board in a chip-on-film (COF) manner to be electrically connected with the display layer 100.

The data driving circuit 100C3 may output grayscale voltages (e.g., data voltages or data signals) to the data lines DL1 to DLm in response to the second control signal CONT2, the horizontal synchronization signal Hsync, and the driving signal DS from the signal control circuit 100C1.

The data driving circuit 100C3 may be implemented as an integrated circuit and may be directly mounted on a predetermined area of the display layer 100 or on a separate printed circuit board in a chip-on-film manner to be electrically connected to the display layer 100, but is not particularly limited thereto. For example, the data driving circuit 100C3 may be formed in the same process as the circuit layer 120 (refer to FIG. 6) in the display layer 100.

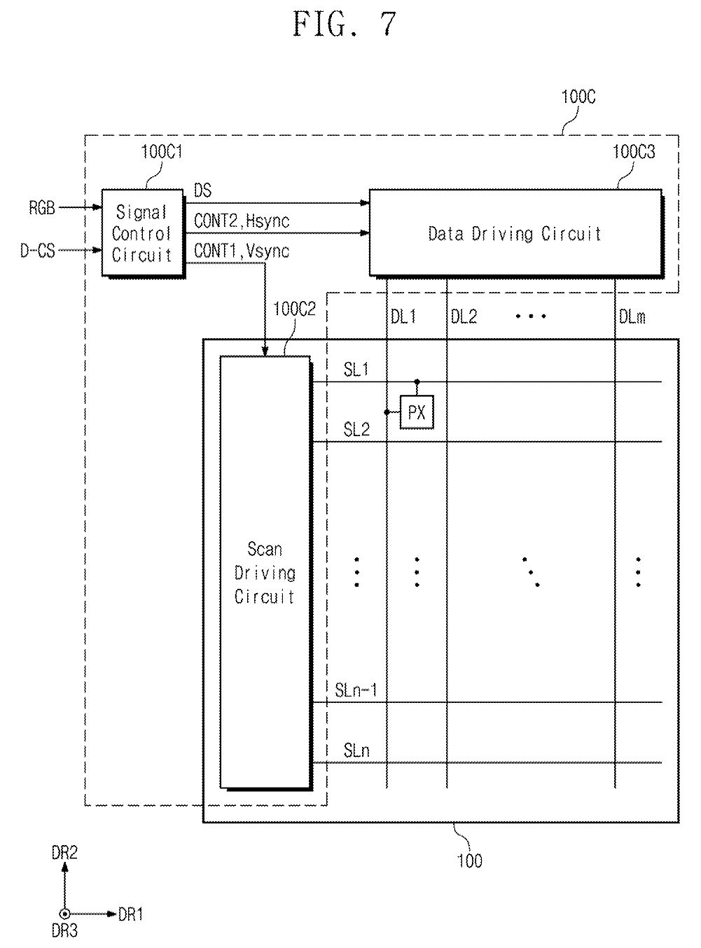

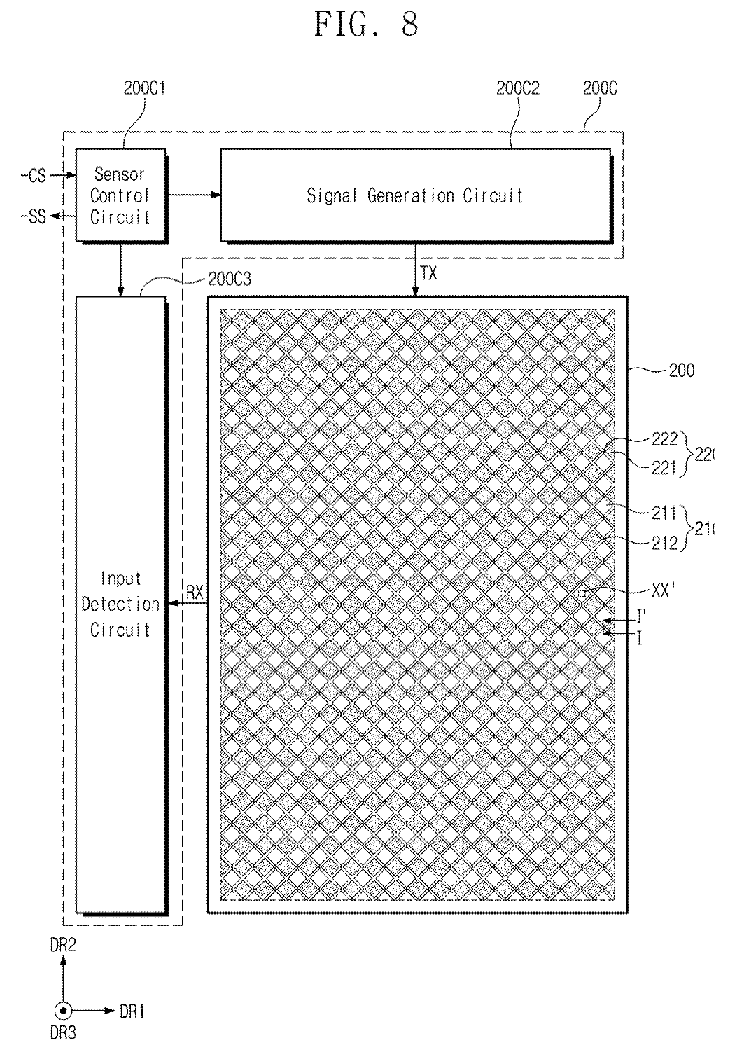

FIG. 8 is a block diagram of the sensor layer 200 and the sensor driver 200C, according to an embodiment of the present disclosure.

Referring to FIG. 8, the sensor layer 200 may include a plurality of first electrodes 210 and a plurality of second electrodes 220. Each of the plurality of second electrodes 220 may intersect the plurality of first electrodes 210. According to some embodiments, the sensor layer 200 may further include a plurality of signal lines connected to the plurality of first electrodes 210 and the plurality of second electrodes 220.

Each of the plurality of first electrodes 210 may extend in the second direction DR2, and the plurality of first electrodes 210 may be arranged to be spaced apart from each other in the first direction DR1. Each of the plurality of second electrodes 220 may extend in the first direction DR1, and the plurality of second electrodes 220 may be arranged to be spaced apart from each other in the second direction DR2. In FIG. 8, 18 first electrodes 210 and 27 second electrodes 220 are illustrated as an example, but the number of first electrodes 210 and the number of second electrodes 220 are not limited thereto.

Each of the plurality of first electrodes 210 may include a sensing pattern 211 and a bridge pattern 212. Two sensing patterns 211 adjacent to each other may be electrically connected to each other by the two bridge patterns 212, but is not particularly limited thereto. The sensing pattern 211 may be included in the second conductive layer 204 (refer to FIG. 6), and the bridge pattern 212 may be included in the first conductive layer 202 (refer to FIG. 6).

Each of the plurality of second electrodes 220 may include a first portion 221 and a second portion 222. The first portion 221 and the second portion 222 may have an integral shape together with each other and may be disposed in the same layer as each other. For example, the first portion 221 and the second portion 222 may be included in the second conductive layer 204 (refer to FIG. 6). The two bridge patterns 212 may be insulated from and crossed with the second portion 222. The first portion 221 may be referred to as a sensing portion, and the second portion 222 may be referred to as a connecting portion. Alternatively, the sensing pattern 211 may be referred to as a first sensing pattern, the bridge pattern 212 may be referred to as a first bridge pattern, the first portion 221 may be referred to as a second sensing pattern, and the second portion 222 may be referred to as a second bridge pattern.

The sensor driver 200C may be implemented as an integrated circuit (IC) and may be directly mounted on a predetermined area of the sensor layer 200 or on a separate printed circuit board in a chip-on-film (COF) manner to be electrically connected to the sensor layer 200.

The sensor driver 200C may include a sensor control circuit 200C1, a signal generation circuit 200C2, and an input detection circuit 200C3. The sensor control circuit 200C1 may control operations of the signal generation circuit 200C2 and the input detection circuit 200C3 based on the control signal I-CS.

The signal generation circuit 200C2 may output transmission signals TX to the first electrodes 210 of the sensor layer 200. The input detection circuit 200C3 may receive detection signals RX from the sensor layer 200. For example, the input detection circuit 200C3 may receive the detection signals RX from the second electrodes 220.

The input detection circuit 200C3 may convert an analog signal into a digital signal. For example, the input detection circuit 200C3 may amplify and then filter the received analog signal. In detail, the input detection circuit 200C3 may convert the filtered signal into a digital signal.

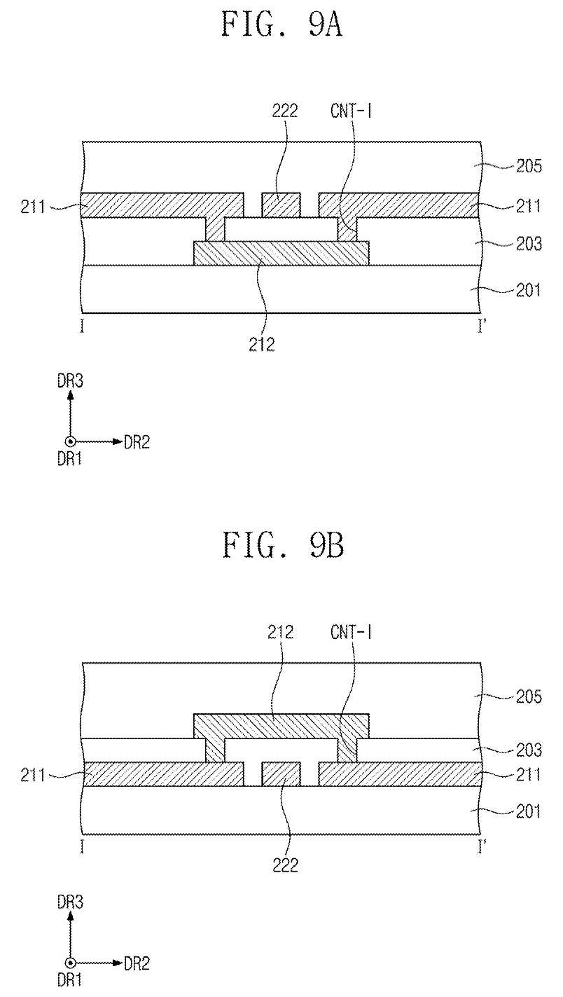

FIG. 9A is a cross-sectional view of a sensor layer taken along a line I-I’ illustrated in FIG. 8, according to an embodiment of the present disclosure.

Referring to FIGS. 6 and 9A, the sensor layer 200 may have a bottom bridge structure. For example, the bridge pattern 212 may be included in the first conductive layer 202 (refer to FIG. 6), and the first portion 221, the second portion 222, and the sensing pattern 211 may be included in the second conductive layer 204 (refer to FIG. 6). The sensing pattern 211 may be connected to the bridge pattern 212 through a contact hole CNT-I penetrating the sensing insulating layer 203.

FIG. 9B is a cross-sectional view of a sensor layer taken along the line I-I’ illustrated in FIG. 8, according to an embodiment of the present disclosure.

Referring to FIGS. 6 and 9B, the sensor layer 200 may have a top bridge structure. For example, the bridge pattern 212 may be included in the second conductive layer 204 (refer to FIG. 6), and the first portion 221, the second portion 222, and the sensing pattern 211 may be included in the first conductive layer 202 (refer to FIG. 6). The bridge pattern 212 may be connected to the sensing pattern 211 through the contact hole CNT-I penetrating the sensing insulating layer 203.

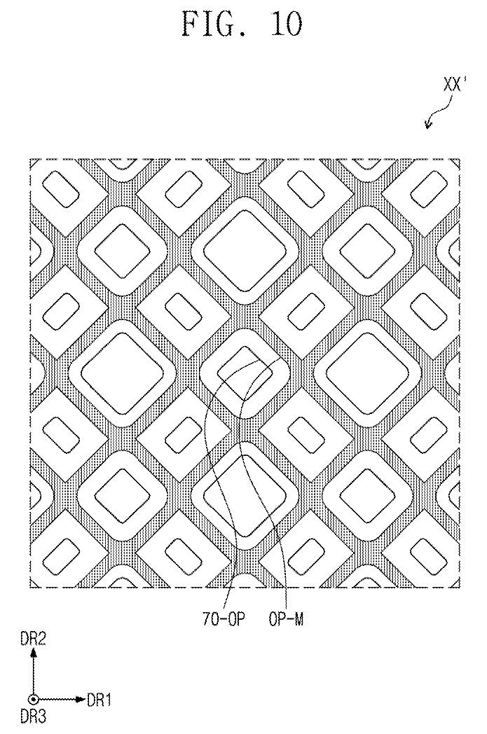

FIG. 10 is an enlarged plane view of an area XX’ illustrated in FIG. 8.

Referring to FIGS. 6 and 10, the sensing pattern 211 may have a mesh structure. An opening OP-M may be defined in the sensing pattern 211. One opening OP-M may overlap with the opening 70-OP defined in the pixel defining film 70 (refer to FIG. 6).

However, this is only an example, and one opening OP-M may overlap with multiple openings 70-OP. Each of the bridge pattern 212, the first portion 221, and the second portion 222 may also have a mesh structure similar to the sensing pattern 211.

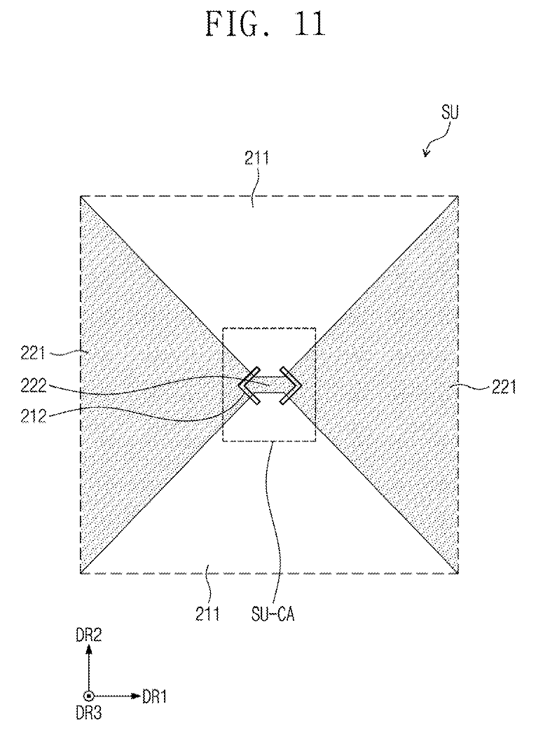

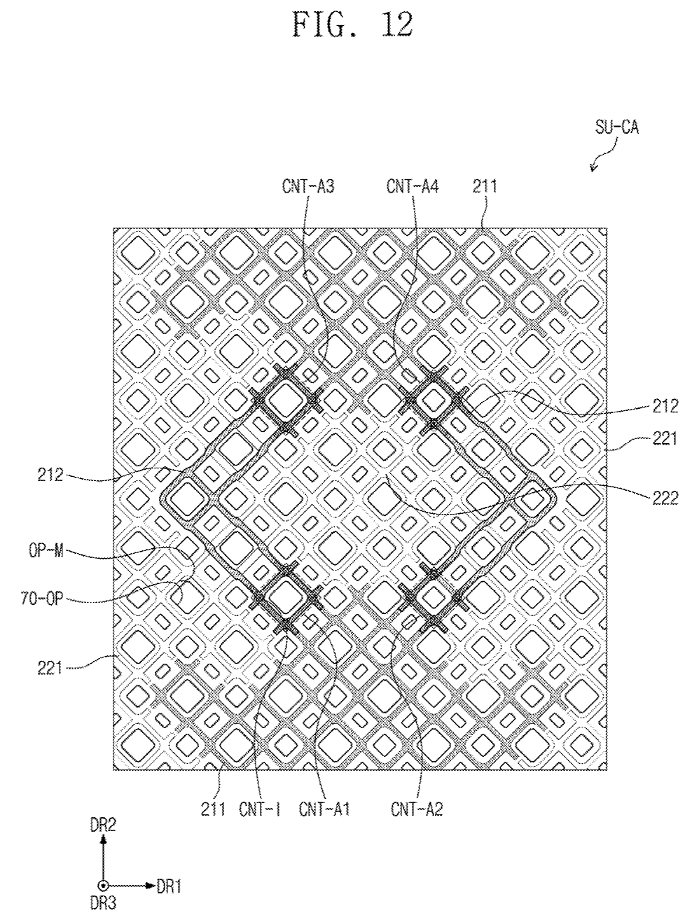

FIG. 11 is a plan view of a sensing unit SU, according to an embodiment of the present disclosure. FIG. 12 is a plan view illustrating an enlarged intersection of the sensing unit SU, according to an embodiment of the present disclosure.

Referring to FIG. 8, FIG. 11, and FIG. 12, the sensor layer 200 may be divided into a plurality of sensing units SU. Each of the sensing units SU may include a corresponding intersection area among the intersection areas of the first electrodes 210 and the second electrodes 220. The intersection area may be an area where the bridge patterns 212 are arranged.

The sensing unit SU may include a half of one first portion 221, a half of another first portion 221, the second portion 222 that is between the one first portion 221 and the other first portion 221, a half of one sensing pattern 211, the two bridge patterns 212, and a half of another sensing pattern 211.

The two bridge patterns 212 may connect the two sensing patterns 211. First to fourth connection areas CNT-A1 to CNT-A4 may be provided between the two bridge patterns 212 and the two sensing patterns 211. Four contact holes CNT-I may be formed in each of the first to fourth connection areas CNT-A1 to CNT-A4. However, this is only an example, and the two sensing patterns 211 may be electrically connected by one bridge pattern. In addition, in an embodiment of the present disclosure, the two sensing patterns 211 may be electrically connected by three or more bridge patterns.

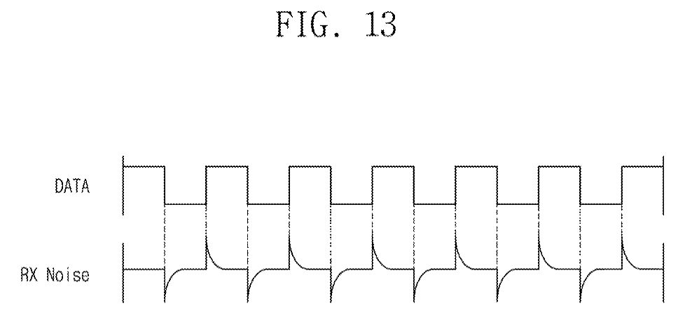

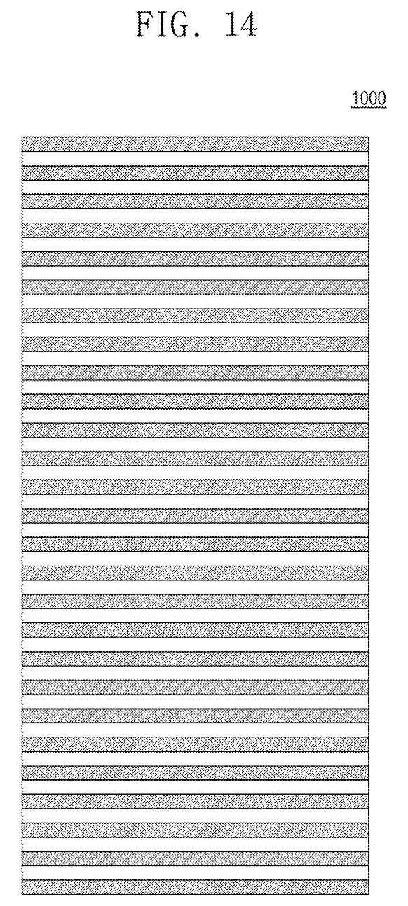

FIG. 13 is a diagram illustrating noise generated in a data signal and a sensor layer, according to an embodiment of the present disclosure. FIG. 14 is a diagram of a data pattern illustrated in an active area of an electronic device, according to an embodiment of the present disclosure. FIG. 15 is a diagram illustrating in detail noise generated in a sensor layer, according to an embodiment of the present disclosure. FIGS. 13 to 15 will be described with reference to FIGS. 7 and 8. The data signal referred to here may be a data signal (e.g., a grayscale voltage or a data voltage) output by the data driving circuit 100C3 of FIG. 7, and the noise generated in the sensor layer 200 may be noise generated in the second electrodes 220.

In FIG. 13, a waveform of the data signal (e.g., the data voltage or the grayscale voltage) output from the data driving circuit 100C3 to the data lines DL1, DL2, ... , DLm is illustrated, and noise generated in the second electrodes 220 due to the influence of the data signal is illustrated. To illustrate this in more detail, in FIG. 14, a 1-line zebra data pattern is illustrated as example data displayed in the active area 1000A of the electronic device 1000, and in FIG. 15, a detailed example waveform of noise generated in the second electrodes 220 due to the influence of a data signal DATA is illustrated.

The change in the data signal DATA may cause noise in the second electrodes 220 by affecting the sensor layer 200 through the encapsulation layer 140 from the circuit layer 120 and/or the light emitting element layer 130 in the display layer 100. The magnitude of this noise may be proportional to the magnitude of the change in the grayscale voltage. The noise introduced into the sensor layer 200 may lower the signal-to-noise ratio (SNR), thereby reducing the touch recognition performance, and may cause abnormal operations such as an incorrect touch detection (a ghost touch).

In embodiments of the present disclosure, to solve this problem, an embodiment of driving the non-driven electrodes among the second electrodes 220 with a compensation signal (e.g., a signal that is the opposite phase of the data signal) and/or an embodiment of outputting the compensation signal through a guard signal line to offset the noise generated in the process of outputting the grayscale voltage from the data driving circuit 100C3 will be described. This reduces display data noise coupled to the detection signal-output electrode during a mutual sensing process, thereby improving the signal-to-noise ratio (SNR) and minimizing abnormal operations such as the incorrect touch detection (the ghost touch).

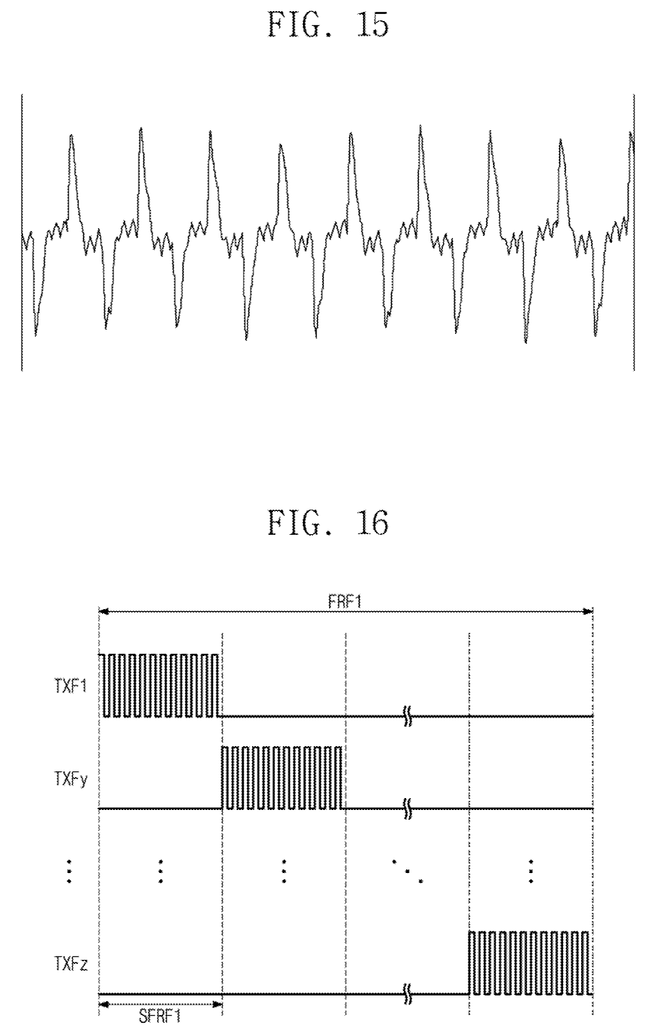

FIG. 16 is a waveform diagram of transmission signals, according to an embodiment of the present disclosure. FIG. 16 will be described with reference to FIG. 8.

In FIG. 16, when defining the time unit in which the sensor layer 200 detects input as a frame, transmission signals TXF1, TXFy, ... , TXFz corresponding to one frame FRF1 are illustrated as an example. In this case, the transmission signals TXF1, TXFy, ... , TXFz may be the transmission signals TX of FIG. 8 output to the first electrodes 210. Here, “y” is an integer greater than or equal to 2, and “z” may be an integer greater than “y”.

The transmission signals TXF1, TXFy, ... , TXFz may be sequentially activated (or driven) within the one frame FRF1. The active state (or driven state) may mean, for example, a state in which the transmission signals TXF1, TXFy, ... , TXFz swing between two voltages in a predetermined voltage range. Transmission signals that are not in the active state may be referred to as a non-active state, a dormant state, a standby state, or a non-driven state. For example, referring to FIG. 16, in a first subframe SFRF1, the transmission signal TXF1 may be activated, and the remaining transmission signals TXFy, ... , TXFz may be deactivated. The frequency of each of the transmission signals TXF1, TXFy, ... , TXFz may be hundreds of kHz, but is not particularly limited thereto.

In one example, since at least one of the transmission signals TXF1, TXFy, ... , TXFz may be output equally to two or more electrodes among the first electrodes 210, the number of transmission signals from TXF1 to TXFz, i.e., “z,” may not be equal to the number of the first electrodes 210. For example, in the first subframe SFRF1, the transmission signal TXF1 may be output to the electrodes of a first group among the first electrodes 210 (the electrodes of the first group may be in the driven state), and at this time, the electrodes of the first electrodes 210, other than the electrodes of the first group, may be in the non-driven state.

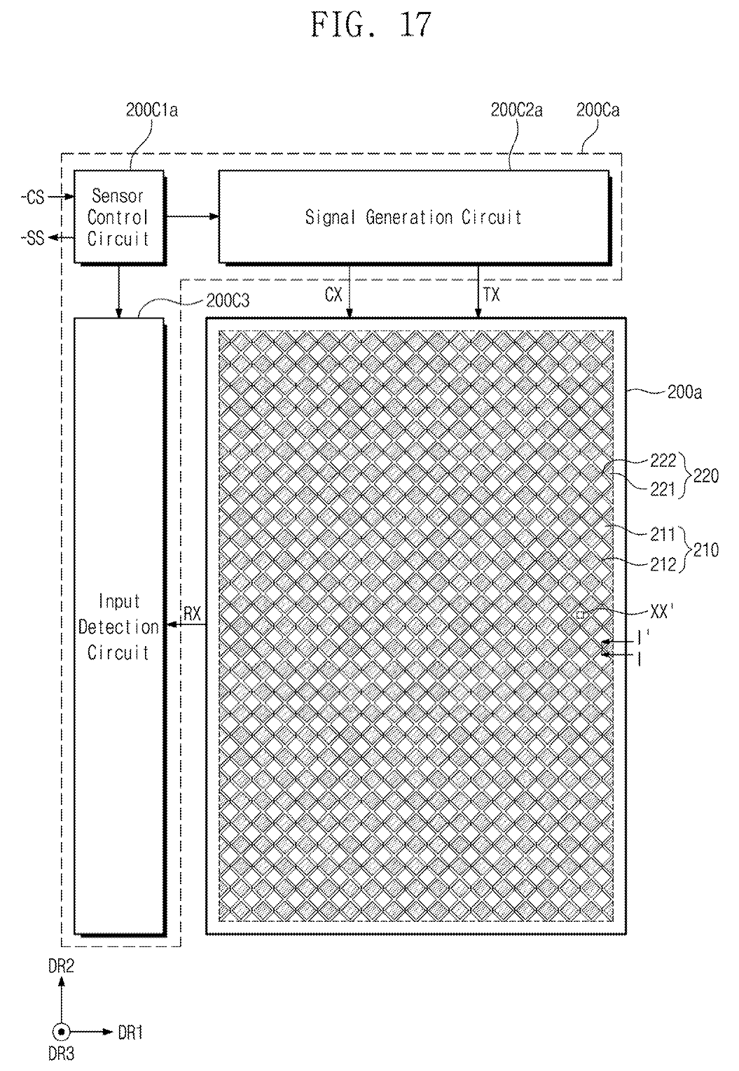

In one example, in the first subframe SFRF1, the same transmission signal (e.g., a signal having the same magnitude and phase) may not be output to all the electrodes in the driven state among the first electrodes 210. For example, when the electrodes in the driven state among the first electrodes 210 are first to fourth driving state electrodes, the same first transmission signal (e.g., transmission signal TXF1 of FIG. 16) may be output to the first to third driving state electrodes, and the second transmission signal (e.g.,, a signal having the opposite phase to TXF1 of FIG. 16) may be output to the fourth driving state electrode. The operation of the driving state electrodes in this manner may be equally applied to the driving state electrodes (electrodes that output activated transmission signals among the first electrodes) of the following FIGS. 17 to 20.

Since the transmission signals TXFy, ... , TXFz are sequentially activated (or driven) in the remaining time sections excluding the first subframe SFRF1, similarly to the first subframe SFRF1 also in the remaining time sections excluding the first subframe SFRF1, at least one of the first electrodes 210 may output the transmission signals TXFy, ... , TXFz, and the remaining electrodes that do not output the transmission signals TXFy, ... , TXFz may be in a non-driven state.

FIG. 17 is a block diagram of a sensor layer and a sensor driver, according to an embodiment of the present disclosure. In the description of FIG. 17, the parts that are different from FIG. 8 may be described, and the same reference numerals are assigned for the same components and the descriptions thereof may be omitted to avoid redundancy.

Referring to FIG. 17, a signal generation circuit 200C2a of a sensor driver 200Ca may output a compensation signal CX. In an example, the compensation signal CX may be output to at least one of the plurality of first electrodes 210a of a sensor layer 200a. Through this, the display data noise coupled to the second electrodes 220 within the sensor layer 200 may be offset.

In an example, the signal generation circuit 200C2a of the sensor driver 200Ca may be configured to output (apply) the compensation signals CX to at least one of the electrodes (electrodes of the first group) in a non-driven state among the first electrodes 210a. For example, the signal generation circuit 200C2a of the sensor driver 200Ca may output the transmission signal TX to the electrodes of the first group among the first electrodes 210a, and may output the compensation signal CX to the electrodes of the second group among the first electrodes 210a. The electrodes of the second group may be some or all of the electrodes of the first electrodes 210, other than the electrodes of the first group. When the electrodes of the second group are some of the electrodes of the first electrodes 210 other than the electrodes of the first group, a third group of electrodes may exist among the first electrodes 210.

A sensor control circuit 200C1a may receive the control signal I-CS from the main driver 1000C (or the processor 12 of FIG. 1) of FIG. 4, and the signal generation circuit 200C2a may generate the compensation signals CX based on the control signal received from the sensor control circuit 200C1a so as to output to at least one of the electrodes (electrodes of the second group) in the non-driven state. That is, the signal generation circuit 200C2a may generate the compensation signals CX based on the control of the main driver 1000C (or the processor 12 of FIG. 1) and may output the compensation signals CX to at least one of the electrodes (electrodes of the second group) in the non-driven state.

In an example, the phase of the compensation signal CX may be determined based on the phase of the data signal DATA (generated by the data driving circuit 100C3 of FIG. 7) of FIG. 13. For example, the phase of the compensation signal CX may be opposite to the phase (inverse phase signal) of the data signal DATA (generated by the data driving circuit 100C3 of FIG. 7) of FIG. 13.

In an example, the magnitude (e.g., voltage level) of the compensation signal CX may be determined based on the magnitude of the data signal DATA (generated by the data driving circuit 100C3 of FIG. 7) of FIG. 13. For example, the magnitude (e.g., voltage level) of the compensation signal CX may be the same as the magnitude of the data signal DATA (generated by the data driving circuit 100C3 of FIG. 7) of FIG. 13.

The magnitude (e.g., voltage level) of the compensation signal CX output from the signal generation circuit 200C2a may be determined in advance or may be adjusted by the sensor driver 200Ca based on the control of the main driver 1000C (or the processor 12 of FIG. 1) and/or the sensor control circuit 200C1a. However, the magnitude (e.g., voltage level) of the compensation signal CX is not limited to the example described in this paragraph, and the magnitude (e.g., voltage level) of the compensation signal CX may be set in various ways based on the model or type of the electronic device 1000 having the sensor layer 200a and the sensor driver 200Ca of FIG. 17.

According to the embodiment described with FIG. 17, unnecessary noise occurring in a mutual sensing environment within the touch panel may be suppressed, and the signal-to-noise ratio (SNR) may be improved. In addition, the magnitude and phase of the compensation signal CX may be adjusted according to the structure of the touch sensor and the characteristics of the display panel, thereby providing an optimized noise suppression effect even in various environments.

Therefore, the TX compensation driving method according to an embodiment of the present disclosure effectively attenuates noise introduced into the detection signal-output electrode in the sensor layer 200, thereby improving touch detection performance and enabling more accurate touch recognition.

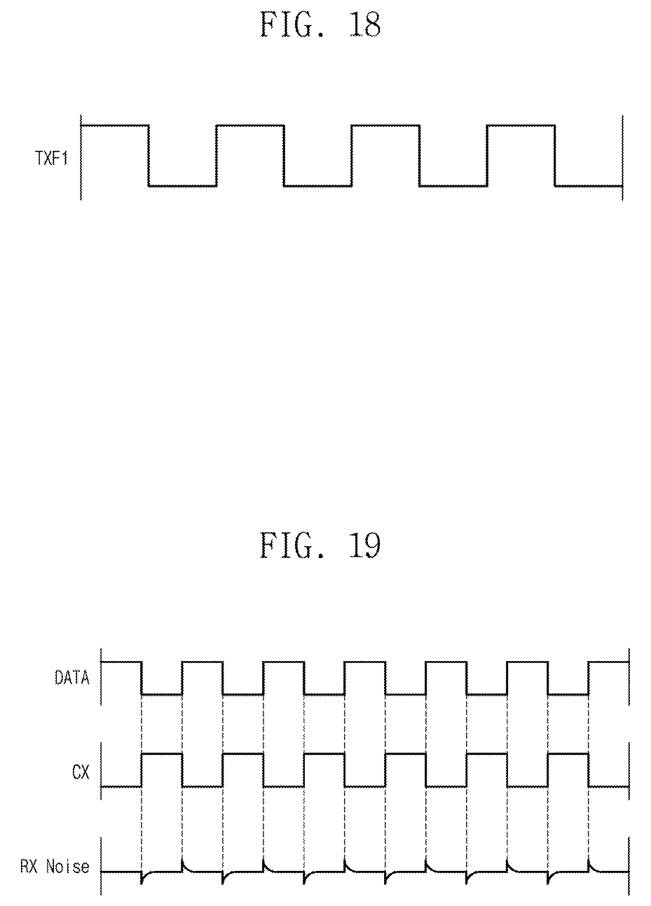

FIG. 18 is a waveform diagram of a transmission signal, a compensation signal, and a data signal, according to an embodiment of the present disclosure. FIG. 19 is a waveform diagram of noise generated in an electrode outputting a data signal, a compensation signal, and a detection signal, according to an embodiment of the present disclosure. FIGS. 18 and 19 will be described with reference to FIGS. 16 and 17. FIG. 18 and FIG. 19 may illustrate waveforms of each signal in a time section corresponding to the first subframe SFRF1 of FIG. 16.

Referring to FIG. 18, in the first subframe SFRF1, the transmission signal TXF1 may be activated, and the other transmission signals TXFy, ... , TXFz may be deactivated. The compensation signal CX having a phase opposite to a phase of the data signal DATA may be output from the signal generation circuit 200C2a to the electrodes corresponding to the deactivated transmission signals TXFy, ... , TXFz (electrodes outputting the deactivated transmission signals TXFy, ... , TXFz among the plurality of first electrodes 210). The data signal DATA may be the same as the data voltage and/or grayscale voltage described above with respect to FIG. 7 and FIG. 13, and thus may be a signal generated by the data driving circuit 100C3 and output to the data lines DL1, DL2, ... , DLm.

In FIG. 19, due to the influence of the compensation signal CX, the noise (RX noise) generated in the second electrodes 220 of FIG. 17 may be reduced compared to the noise of FIG. 13 (when the compensation signal is not applied).

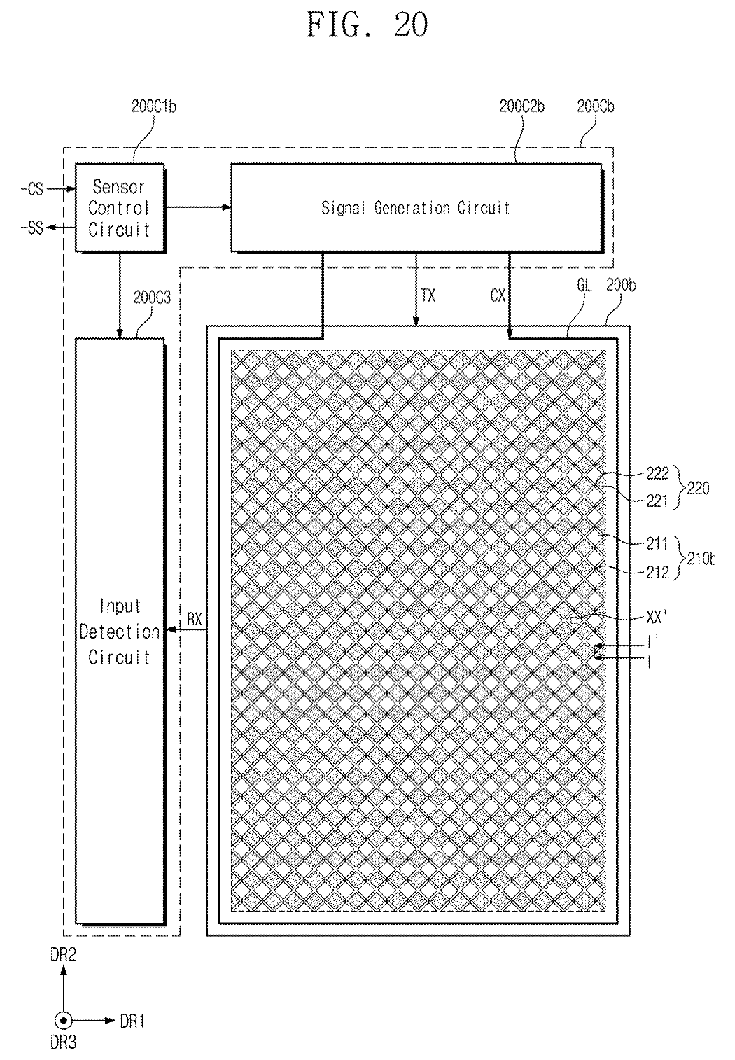

FIG. 20 is a block diagram of a sensor layer and a sensor driver, according to an embodiment of the present disclosure. A sensor layer 200b may further include a guard signal line GL. Although FIG. 20 illustrates one guard signal line GL as a representative example, the sensor layer 200b may include a plurality of guard signal lines.

In an example, the guard signal line GL may be arranged at a position spaced apart from the first electrodes 210 and the second electrodes 220 within the sensor layer 200b. The guard signal line GL may function as a wire for suppressing display data noise occurring in a mutual sensing environment. The guard signal line GL may block signal interference that may be introduced into the second electrodes 220 that output the detection signals RX to the input detection circuit 200C3, and may provide a noise shielding effect by maintaining a specific potential.

Referring to FIG. 20, the guard signal line GL may be arranged on the outside of the area where the electrodes of the sensor layer 200b are located to reduce the influence of noise. The arrangement of the guard signal line GL is not limited to the example of FIG. 20, and may be arranged in parallel with the first electrodes 210 and/or the second electrodes 220.

A signal generation circuit 200C2b of a sensor driver 200Cb may output a guard signal and/or the compensation signal to the guard signal line GL. In one example, the signal generation circuit 200C2b may output the compensation signal CX of FIG. 19 to the guard signal line GL. A sensor control circuit 200C1b may receive the control signal I-CS from the main driver 1000C (or the processor 12 of FIG. 1) of FIG. 4, and the signal generation circuit 200C2b may generate the compensation signal CX based on the control signal received from the sensor control circuit 200C1b so as to output to the guard signal line GL. That is, the signal generation circuit 200C2b may generate the compensation signal CX based on the control of the main driver 1000C (or the processor 12 of FIG. 1) so as to output to the guard signal line GL.

In an example, the signal generation circuit 200C2b of the sensor driver 200Cb may output the compensation signal CX to the guard signal line GL while outputting an activated transmission signal (e.g., TXF1 in the first subframe SFRF1 of FIG. 16) to the electrodes of the first group among the first electrodes 210b. For example, the signal generation circuit 200C2b may simultaneously output the transmission signal (e.g., TXF1 of FIG. 18) to the electrodes of the first group in the driven state and the compensation signal CX to the guard signal line GL. The signal generation circuit 200C2b may continuously output the compensation signal CX to the guard signal line GL while the transmission signals TXF1, TXFy, ... , TXFz are sequentially activated within the one frame FRF1.

In an example, the phase and/or magnitude (e.g., voltage level) of the compensation signal CX output from the signal generation circuit 200C2b to the guard signal line GL may be determined based on the data signal DATA (generated by the data driving circuit 100C3 of FIG. 7) of FIG. 13. For example, the phase of the compensation signal CX output from the sensor driver 200Cb to the guard signal line GL may be opposite to the phase of the data signal DATA, which may follow the embodiment of FIG. 19. Through this, it is possible to minimize the electric field interference occurring within the sensor layer 200b. In addition, the magnitude (e.g., voltage level) of the compensation signal CX output to the guard signal line GL may be the same as the magnitude (e.g., voltage level) of the data signal DATA.

The magnitude (e.g., voltage level) of the compensation signal CX output to the guard signal line GL may be determined in advance or may be adjusted by the sensor driver 200Cb based on the control of the main driver 1000C (or the processor 12 of FIG. 1) and/or the sensor control circuit 200C1b. However, the magnitude (e.g., voltage level) of the compensation signal CX is not limited to the example described in this paragraph, and the magnitude (e.g., voltage level) of the compensation signal CX may be set in various ways based on the model or type of the electronic device 1000 having the sensor layer 200b and the sensor driver 200Cb of FIG. 20.

According to the embodiment described with reference to FIG. 20, the coupling signal to the detection signal-output electrode may be effectively reduced, thereby improving the signal-to-noise ratio (SNR) and enhancing the touch detection performance.

In the present disclosure, although FIGS. 17 and 20 are illustrated and described separately, the embodiment of FIG. 17 and the embodiment of FIG. 20 may be may be combined. In the case where the embodiments of FIGS. 17 and 20 are combined, the compensation signal may be output to the first electrodes 210 and/or the guard signal line GL.

According to an embodiment of the present disclosure, data noise coupled to the detection signal-output electrode may be effectively attenuated.

Since noise introduced to the detection signal-output electrode is offset, the touch detection performance may be improved. In addition, unnecessary signal interference to the detection signal-output electrode may be reduced, thereby improving the signal-to-noise ratio (SNR), which may increase the reliability of touch detection and may reduce the possibility of malfunction.

In addition, since unnecessary noise introduction is minimized through the compensation driving method, the phenomenon of false touch detection (Ghost Touch) may be reduced. Therefore, not only more accurate touch detection is possible, but also the user experience may be improved.

In addition, embodiments of the present disclosure may adjust the voltage range of the signal for compensation driving according to the characteristics of the display panel. Accordingly, optimized application to various touch sensors and display structures may be enabled.

Therefore, in embodiments of the present disclosure, not only the touch detection performance may be improved, but also reliability may be improved and a touch solution optimized for the display environment may be provided.

At least one of the components, elements, modules or units (collectively “components” in this paragraph) represented by a block or an equivalent indication in the drawings including FIGS. 1, 4, 7, 8, 17 and 20 may be implemented or embodied by analog and/or digital circuits including one or more of a logic gate, an integrated circuit, a microprocessor, a microcontroller, a memory circuit, a passive electronic component, an active electronic component, an optical component, and the like. Alternatively or additionally, these components may be implemented or embodied by software including one or more instructions stored in an internal or external storage medium that is readable by at least one processor. For example, the at least one processor may invoke at least one of the one or more instructions stored in the storage medium, and execute it, with or without using one or more other components under the control of the at least one processor. This allows the at least one processor to perform at least one function or operation described above as being performed by each of the components according to the at least one instruction invoked. Here, the at least one processor may include a central processing unit (CPU), a graphic processing unit (GPU), another type of microprocessor, not being limited thereto.

Although non-limiting embodiments of the present disclosure are described herein with reference to the accompanying drawings, it will be understood by persons of ordinary skill in the art that various modifications and substitutions are possible, without departing from the spirit and the scope of the present disclosure. Accordingly, the various modifications and substitutions are included within the spirit and scope of the present disclosure.

What is claimed is:

1. An electronic device comprising:
a display layer configured to display an image, the display layer comprising:
a plurality of data lines; and
pixels each connected to a corresponding data line among the plurality of data lines;
a display driver configured to output data signals to the plurality of data lines;
a sensor layer on the display layer, the sensor layer comprising a plurality of first electrodes and a plurality of second electrodes; and
a sensor driver configured to drive the sensor layer,
wherein the plurality of first electrodes comprises electrodes of a first group and electrodes of a second group, and
wherein the sensor driver is configured to:
output transmission signals to the electrodes of the first group;
output compensation signals to the electrodes of the second group; and
receive detection signals from the plurality of second electrodes.

2. The electronic device of claim 1, further comprising a main driver that is configured to control the sensor driver to output the compensation signals,
wherein the main driver is configured to control a phase of the compensation signals based on a phase of the data signals.

3. The electronic device of claim 1, wherein the compensation signals have a phase opposite to a phase of the data signals.

4. The electronic device of claim 1, further comprising a main driver that is configured to control the sensor driver to output the compensation signals,
wherein the main driver is configured to control a voltage level of the compensation signals based on a voltage level of at least one of the data signals.

5. The electronic device of claim 1, wherein the compensation signals have a voltage level equal to a voltage level of at least one of the data signals.

6. The electronic device of claim 1, wherein the sensor driver is configured to drive the electrodes of the first group while the electrodes of the second group are in a non-driven state.

7. The electronic device of claim 1, wherein the sensor driver is configured to simultaneously output the transmission signals to the electrodes of the first group and the compensation signals to the electrodes of the second group.

8. An electronic device comprising:
a display layer configured to display an image, the display layer comprising:
a plurality of data lines; and
pixels each connected to a corresponding data line among the plurality of data lines;
a display driver configured to output data signals to the plurality of data lines;
a sensor layer on the display layer, the sensor layer comprising a plurality of first electrodes, a plurality of second electrodes, and a guard signal line; and
a sensor driver configured to drive the sensor layer,
wherein the plurality of first electrodes comprises electrodes of a first group and electrodes of a second group, and
wherein the sensor driver is configured to:
output transmission signals to the electrodes of the first group;
output at least one compensation signal to the electrodes of the second group or the guard signal line; and
receive detection signals from the plurality of second electrodes.

9. The electronic device of claim 8, further comprising a main driver that is configured to control the sensor driver to output the compensation signals,
wherein the main driver is configured to control a phase of the at least one compensation signal based on a phase of the data signals.

10. The electronic device of claim 8, wherein the at least one compensation signal has a phase opposite to a phase of the data signals.

11. The electronic device of claim 8, further comprising a main driver that is configured to control the sensor driver to output the compensation signals,
wherein the main driver is configured to control a voltage level of the at least one compensation signal based on a voltage level of at least one of the data signals.

12. The electronic device of claim 8, wherein the at least one compensation signal has a voltage level equal to a voltage level of at least one of the data signals.

13. The electronic device of claim 8, wherein the sensor driver is configured to drive the electrodes of the first group while the electrodes of the second group are in a non-driven state.

14. The electronic device of claim 8, wherein the sensor driver is configured to simultaneously output the transmission signals to the electrodes of the first group and the at least one compensation signal to the electrodes of the second group or the guard signal line.

15. An electronic device comprising:
a display layer configured to display an image, the display layer comprising:
a plurality of data lines; and
pixels each connected to a corresponding data line among the plurality of data lines;
a display driver configured to output data signals to the plurality of data lines;
a sensor layer on the display layer, the sensor layer comprising a plurality of first electrodes and a plurality of second electrodes;
a sensor driver configured to drive the sensor layer; and
a processor configured to control an operation of the display driver and the sensor driver,
wherein the plurality of first electrodes comprises electrodes of a first group and electrodes of a second group, and
wherein the sensor driver is configured to:
output transmission signals to the electrodes of the first group;
output compensation signals to the electrodes of the second group based on control of the processor; and
receive detection signals from the plurality of second electrodes.

16. The electronic device of claim 15, wherein the processor is configured to control a phase of the compensation signals based on a phase of the data signals.

17. The electronic device of claim 15, wherein the compensation signals have a phase opposite to a phase of the data signals.

18. The electronic device of claim 15, wherein the processor is configured to control a voltage level of the compensation signals based on a voltage level of at least one of the data signals.

19. The electronic device of claim 15, wherein the sensor driver is configured to drive the electrodes of the first group while the electrodes of the second group are in a non-driven state.

20. The electronic device of claim 15, wherein the sensor driver is configured to, based on the control of the processor, simultaneously output the transmission signals to the electrodes of the first group and the compensation signals to the electrodes of the second group.
